(19) United States
(12) Patent Application Publication
(10) Pub. No.: US 2025/0200393 A1
(43) Pub. Date: Jun. 19, 2025

(54) Computer-implemented method for monitoring the reliability of a prediction system, computer program product and machine installation

(71) Applicant: Siemens Aktiengesellschaft, München (DE)

(72) Inventors: Thomas Bierweiler, Stutensee (DE); Herbert Grieb, Malsch (DE); Piotr Strauch, Rülzheim (DE); Wolfgang Ziegler, Kandel (DE); Ralph Fehrer, Rheinstetten (DE)

(73) Assignee: Siemens Aktiengesellschaft, München (DE)

(21) Appl. No.: 18/539,810

(22) Filed: Dec. 14, 2023

(51) Int. Cl. G06N 5/022

(52) U.S. Cl. CPC G06N 5/022

(57) ABSTRACT

The invention relates to a computer-implemented method for monitoring a prediction system, wherein the prediction system is configured to predict at least one process variable of a machine based on at least one measured value. The method comprising a first step, in which the machine is being run and the at least one measured value is received. The measured value substantially simultaneously fed into the prediction system and an anomaly detection algorithm. In a second step, an anomaly parameter is obtained from the anomaly detection algorithm. In a third step, an unreliable state of the prediction system is detected when the anomaly parameter exceeds a threshold. During a fourth step, a warning is output to at least one of a user or a data interface. The invention also relates to a computer program product that is configured to perform the claimed computer-implemented method and a machine installation on which such a computer program product is run.

### BACKGROUND

The invention relates to a computer-implemented method for monitoring a prediction system and a computer program product configured to perform such a method. The invention also relates to a machine installation that comprises an evaluation unit which is equipped with such a computer program product.

### DESCRIPTION OF THE RELATED ART

The article “Efficient technique improves machine-learning model's reliability” by Adam Zewe; Feb. 13, 2023; MIT News Office, published online at http://news.mit.edu/2023/improving-machine-learning-models-reliability-0213; discloses a metamodel that is used to quantify an uncertainty of an existing pretrained model. The metamodel applies data uncertainty and model uncertainty. Model uncertainty encompasses that a pretrained model may be exposed to a situation that deviates from its original training data.

Prediction systems are being used in a variety of technical applications, especially in the field of turbomachinery, such as power plant turbines or large-scale reciprocating engines. Particularly, prediction systems may be used to predict emissions from such machines. Many prediction systems are based on machine-learning algorithms which make them unintuitive for most people. Therefore, it is virtually impossible to tell if a prediction value from such a prediction system is sufficiently precise or in some cases, even realistic. It is desirable to have a method that can detect if a running prediction system can be relied upon or not quickly, reliably and intuitively. It is an object of the invention to provide a solution that offers an improvement in at least one of these aspects.

### SUMMARY

The object described above is achieved by a computer-implemented method for monitoring a prediction system. The prediction system is configured to predict at least one process variable of a machine. The process variable is obtained based on at least one measured value. The computer-implemented method comprises that the machine is being run. Furthermore, the at least one measured value is being received and fed into the prediction system. Substantially simultaneously, the at least one measured value is also fed into an anomaly prediction algorithm. The computer-implemented method further comprises that an anomaly parameter is obtained from the anomaly detection algorithm. Furthermore, the computer-implemented method also comprises that an unreliable state of the prediction system is detected when the anomaly parameter exceeds a threshold. Still further, the computer-implemented method comprises that a warning is output.

The described object is also achieved by a computer program product which comprises a computer-readable program code that is embodied on a non-transitory storage medium. The program code is configured to receive and process the measured values measured at the machine when it is loaded into a memory of an evaluation unit. When loaded into the memory of the evaluation unit, the computer program product causes the evaluation unit to monitor a prediction system of the machine. To that end, the computer program product is configured to perform a step in which it receives the at least one measured value that is measured at the machine when it is running. During that step, the at least one received measured value is fed into the prediction system and into an anomaly detection algorithm substantially simultaneously. Furthermore, the computer program product is configured to perform another step in which an anomaly parameter is obtained from the anomaly detection algorithm. In yet another step, an unreliable state of the prediction system is detected when the anomaly parameter exceeds a threshold. The computer program product is also configured to perform yet another step in which a warning is output.

The object outlined above is also achieved by an evaluation unit that comprises a non-transitory memory and a processor which are configured to run a computer program product. The evaluation unit configured to receive and process the measured values. The evaluation is configured to perform a step in which it receives at least one measured value that is measured at the machine when it is running. During that step, the at least one received measured value is fed into the prediction system and into the anomaly detection algorithm substantially simultaneously. Furthermore, the evaluation unit is configured to perform another step in which the anomaly parameter is obtained from the anomaly detection algorithm. In yet another step, an unreliable state of the prediction system is detected when the anomaly parameter exceeds a threshold. The evaluation unit is also configured to perform yet another step in which the warning is output.

### BRIEF DESCRIPTION OF THE DRAWINGS

In the following, the present invention is described in more detail in several figures. The figures are to be construed as mutually complementary. Particularly, identical numerals are to be construed as having the same technical meaning. The features of the embodiments shown in the figures may be combined with each other. Additionally, the features of the embodiments shown in the figures may also be combined with the embodiments outlined above. In particular, the figures show:

FIG. 1 a schematic depiction of a first embodiment of the claimed computer-implemented method;

FIG. 2 a flow diagram of a second embodiment of the claimed computer-implemented method.

### DETAILED DESCRIPTION

The claimed computer-implemented method is configured for monitoring a prediction system. The prediction system is configured to predict at least one process variable of a machine to which it is connected. A process variable may be a physical quantity which is affected by how the machine is being operated. Furthermore, the process variable may also indicate a quality of the operation of the machine. The prediction system is configured to predict the process variable based on at least one measured value. The measured value is a physical quantity that is different from the process variable. The measured value may be any quantity that relates to the operation of the machine, and which may directly be affected by an operator. For example, the measured value may be a rotational speed of a turbo machine and the prediction value may be the composition of its exhaust.

The computer-implemented method comprises a first step, during which the machine is being run. Furthermore, at least one measured value is being received, for example from a sensor connected to the machine, and fed into the prediction system. Substantially simultaneously, the at least one measured value is also fed into an anomaly prediction algorithm. Thus, the prediction system and the anomaly detection algorithm receive substantially the same input and operate in lockstep.

In a second step, an anomaly parameter is obtained from the anomaly detection algorithm. To that end, the measured value fed into the anomaly detection algorithm is processed to indicate if the measured value lies within a framework that describes the current operation of the machine. The computer-implemented method also comprises a third step in which an unreliable state of the prediction system is detected when the anomaly parameter exceeds a threshold. The threshold may be a predefined threshold or an adaptive threshold. The anomaly parameter quantifies to which extend the measured value lies within its pertinent framework of reference or not. Thus, the anomaly detection algorithm indicates if the present operating situation of the machine is normal or not.

After that, a fourth step is performed in which a warning is output to at least one of a user and a data interface. The warning indicates that the prediction system is currently facing an operating situation for which it is not well-suited and that its predictions may not sufficiently reflect reality. The warning may be used to warn a user, e. g. a machine operator, directly or to communicate the detected unreliable state to a control program that controls the machine.

Among other things, the invention is based on the surprising finding that anomaly detection algorithms are well-suited to judge if a prediction system is familiar enough with a present operating situation to make reliable and precise predictions and to which extends. Anomaly detection algorithms of several kinds are readily available and are technically mature enough to be relied upon. In addition to that, anomaly detection algorithms run significantly faster than most prediction systems. Therefore, having a prediction system and an anomaly detection algorithm in parallel will not affect the running speed of the prediction system. One more surprising finding is, that in terms of quantity, the anomaly parameter corresponds well with the reliability of the prediction system. The threshold defines at which degree of reliability or unreliability the warning will be output. That allows for defining the sensitivity of the computer-implemented method. The threshold may be defined by at least one of the user and an artificial intelligence. The threshold may also be defined based on known states of the machine which are different from the states described by the training data.

Altogether, the computer-implemented method allows for avoiding running the machine based on unreliable predictions, which can lead to unintended consequences like excessive wear or excessive emissions. Therefore, the computer-implemented method provides for a more cost-efficient and safe operation of the machine. The computer-implemented method also allows for expediting a commissioning process of the machine. Every time the computer-implemented method detects an unreliable state of the prediction system, the prediction system is not available. In turn, unprecise predictions by the prediction system are omitted, which increases the overall precision of the prediction system. By adjusting the threshold, the computer-implemented method may be configured to provide selectable minimum of availability and a resulting maximum of precision, wherein the minimum of availability may be defined by standards governing the operation of the machine. Thus, the computer-implemented method is suitable to be adapted for a broad range of applications.

In an embodiment of the claimed computer-implemented method, the prediction system comprises a prediction algorithm that is a machine-learning algorithm which is trained based on a set of training data. Correspondingly, the anomaly detection algorithm is also a machine-learning algorithm which is trained based on a set of training data. According to the claimed computer-implemented method, the prediction algorithm and the anomaly detection algorithm are trained based on substantially the same training data. The training data defines a set of operating situations the prediction algorithm is most familiar with and for which it yields the most precise predictions. The more dissimilar a present operating situation is from the training data, the less precise, and therefore less reliable, the prediction algorithm can be. The claimed computer-implemented method allows for yielding more use from the training data that is necessary for training the prediction algorithm. Thus, the claimed computer-implemented method is relatively easy to implement and therefore cost-efficient.

In another embodiment of the claimed computer-implemented method, an unreliable state of the prediction system is detected when the anomaly parameter exceeds the threshold at least for a predefined time interval. The time interval may be set by the user or the artificial intelligence. The allowable range for the time interval may be defined by a standard that governs the operation of the machine. The time interval may be long enough to receive multiple measurements of the measured value and to process them. If the anomaly parameter exceeds its threshold for a period that is shorter than the predefined time interval, it may be dismissed as a transient disturbance that does not have any substantial bearing on the prediction system and the machine. Alternatively or additionally, a statistical evaluation of the anomaly parameter may be performed to detect if the corresponding threshold is sufficiently exceeded. The definition of the time interval allows for adjusting the sensitivity of the claimed computer-implemented method. Particularly, a propensity to falsely indicate unreliable states may be reduced. That allows for deploying the claimed computer-implemented method even in applications with volatile measured values. The time interval may be substantially 30 minutes when the measured value is a concentration of a component of the exhaust of the machine.

Furthermore, the claimed computer-implemented method comprises that the anomaly detection algorithm is also used to detect anomalies of the machine during its operation. The anomaly detection algorithm may apply different thresholds for the detection of anomalies of the machine than for monitoring the prediction algorithm. That allows for deriving more information from the data generated by the anomaly detection algorithm, i.e. the anomaly parameter. Different thresholds for the same anomaly parameter can easily be implemented and do not significantly slow down the anomaly detection algorithm. The claimed computer-implemented method provides a simple, yet surprisingly effective way to monitor the reliability of the underlying prediction system. Alternatively, the anomaly prediction algorithm may substantially be a clone of the anomaly prediction algorithm that is used to detect anomalies of the machine during its operation. That allows for running the computer-implemented method on a separate platform that only requires a minimum of interaction with the prediction system and the anomaly detection system that is used to monitor the machine. Consequently, the claimed computer-implemented method may be performed by an evaluation unit that is an add-on device for a control unit or a monitoring unit of the machine.

Still further, the prediction system may comprise a machine-learning algorithm. A machine-learning algorithm is to be construed as an algorithm that processes training data to adjust itself to its task at hand. Machine-learning algorithms allow for quick unerring recognition of trained situations or similar ones. Once trained, machine-learning algorithms may assume a complexity that is difficult to analyze, thus complicating their understanding. The claimed computer-implemented method is suitable to detect if such a prediction system is currently receiving measured values, i.e. input, which can yield a precise prediction. Thus, the claimed computer-implemented method allows for countering a drawback of such prediction systems without adding even more complexity to them. For example, the machine-learning algorithm may be at least one of a gradient boosting machine, a support vector machine, a k-nearest neighbor algorithm, a recurrent neural network, a long short-term memory neural network, a convolutional neural network and a combination thereof. The claimed computer-implemented method is independent of the type of the prediction system and thus has a broad spectrum of application. It may also be easily implemented as an addition to an existing prediction system. Even with further progress in the field of prediction algorithms, the claimed computer-implemented method may be used in combination with them since it substantially runs in parallel to it.

In the claimed computer-implemented method, the prediction system may comprise a machine-learning algorithm. The machine-learning algorithm may be at least one of an auto encoder, an isolation forest algorithm, a local outlier factor algorithm and a combination thereof. Such machine-learning algorithms also allow for predicting a process value during a planned operation of a machine and also have receding prediction precision when the machine is operated under uncommon conditions. It is another surprising finding of the present invention, that an anomaly detection algorithm is also suitable to detect if such prediction systems still offer sufficiently reliable predictions for the process variable.

In another embodiment, the claimed computer-implemented method comprises a fifth step in which a margin of error parameter is set based on the anomaly parameter that is obtained in the second step. Furthermore, a prediction value for the process variable is obtained from the prediction system. The margin of error parameter may be an absolute value or an interval. In a sixth step, the margin of error parameter is applied to the prediction value. That encompasses determining a range around the prediction value in accordance with the margin of error parameter. Still further, the prediction value is output with an indication of its margin of error. That prediction value and its margin of error may be output to at least one of the user and the data interface. The more the anomaly parameter exceeds its threshold, the higher the margin of error parameter is. That allows the user, the control unit or the evaluation unit of the machine to intervene in the planned operation of the machine.

In yet another embodiment of the claimed computer-implemented method, it comprises a seventh step. During the seventh step, a control routine of the machine is disengaged when an unreliable state of the prediction system is detected. The control routine may be configured to receive the prediction value from the prediction system as an input. Particularly, the control routine may be configured to output a control signal to the machine, the control signal being determined based on the prediction value. The control routine may be a control loop, embodied either as software, a hardware circuit or a combination of them. The control routine may also be a section of code in a control program of the machine. With the control routine being disengaged, an alternative control routine may be engaged. Thus, the claimed computer-implemented program allows for preventing a machine from being operated based on unprecise or even erroneous prediction values. That may encompass switching the machine into a safe operation mode in which it is only subjected to reduced wear.

In the claimed computer-implemented method, the machine that is connected to the prediction system, may be one of a turbo machine and a reciprocating engine. Furthermore, the prediction system may be configured to predict the emissions of the machine, for example the composition of its exhaust or the amount of exhaust. In turbo machines, for example power plant turbines, the composition of its exhaust is cumbersome to measure directly. Anomaly detection algorithms for turbo machines and reciprocating engines are proven and have reached significant technological maturity, thus allowing for a reliable detection of abnormal operational states. As a consequence, the claimed computer-implemented method is well-suited for monitoring the reliability of a prediction system that is configured to predict the composition of the exhaust from a turbo machine or a reciprocating engine. Especially in combination with power plant turbines, the claimed computer-implemented method allows for operating the power plant turbine more environmentally friendly.

In another embodiment of the claimed computer-implemented method, a multitude of anomaly parameters are obtained during the second step. The multitude of anomaly parameter is obtained based on multiple measured values. Either of them or both are fed into an outlier detection algorithm, that is configured to identify at least one of a measured value and an anomaly parameter as an outlier. During the claimed computer-implemented method, at least one of a measured value and an anomaly parameter may be identified as outliers and may be suppressed for further processing in the course of the claimed computer-implemented method. An anomaly parameter or a measured value may assume an abnormal value without any abnormal state of the machine itself. For example, a sensor reading may be excessive briefly when it is switched on or off. The outlier detection algorithm reduces the number of falsely identified unreliable states of the prediction system. Therefore, the claimed computer-implemented method is robust and suitable for use in rough environments.

The claimed computer program product comprises a computer-readable program code that is embodied on a non-transitory storage medium. The program code is configured to receive and process measured values measured at a machine when it is loaded into a memory of an evaluation unit. Furthermore, when loaded into the memory of the evaluation unit, the computer program product causes the evaluation unit to monitor a prediction system of the machine. To that end, the computer program product is configured to perform a first step in which it receives at least one measured value that is measured at the machine when it is running. During the first step, the at least one received measured value is fed into the prediction system and into an anomaly detection algorithm substantially simultaneously. By virtue of that substantially simultaneous input, the prediction system and the anomaly detection algorithm operate substantially in parallel.

Still further, the computer program product is configured to perform a second step in which an anomaly parameter is obtained from the anomaly detection algorithm. The anomaly parameter is obtained from a calculation performed based in the input measured value. In a third step, and unreliable state of the prediction system is detected when the anomaly parameter exceeds a threshold. The threshold may be defined by at least one of a user, an artificial intelligence and a validation data set, which comprises data about at least one known abnormal state of the machine. When the anomaly parameter stays below the threshold, a reliable state of the prediction system is detected. The threshold allows for adjusting the sensitivity of the monitoring process performed by the claimed computer program product. The computer program product is also configured to perform a fourth step in which a warning is output to at least one of a user and a data interface, the warning indicating that the prediction system is in an unreliable state. The warning that is output through the data interface may be guided to a control unit of the machine which is configured to react to the unreliable state of the prediction system.

The claimed computer program product may be configured to perform at least one of the computer-implemented methods outlined above. Thus, the features of the computer-implemented method also apply to the computer program product and vice versa. The computer program product may be embodied as a piece of software, an integrated circuit, a chip, an FPGA or a combination of any of these. Furthermore, the computer program product may be a monolithic program that is configured to run on a single hardware platform or a modular software with a set of programs that interact with each other.

The claimed evaluation unit is configured to be directly or indirectly connected to sensors and to receive measurements from them. The sensors may be installed at a machine and may be configured to capture physical quantities that characterize the present operational state of the machine. The evaluation unit is also configured to process such measurements from the sensors, for example measured values, to monitor a prediction system of the machine. To that end, the evaluation unit comprises at least one of a transitory and a non-transitory memory that is suitable to store a computer program product and a processor that is configured to execute that computer program product. The computer program product may be embodied according to one of the examples described above. For example, the evaluation unit may be a single hardware platform or a set of hardware platforms which are connected to each other, and which interact to run the computer program product. The evaluation unit may be a computer, a programmable logic control, briefly PLC, or a computer-cloud.

The claimed machine installation comprises a machine that is equipped with sensors for measuring multiple measured values that relate to a present operation of the machine. The machine installation also comprises an evaluation unit that is connected to the sensors and that is configured to process the measured values from the sensors. According to the invention, the evaluation unit is equipped with a computer program product pursuant to one of the embodiments described above. The advantages of the computer program product, which may implement a computer-implemented method as outlined above, also apply to the claimed machine installation. Particularly, the machine may be a turbo machine like a power plant turbine or a reciprocating engine, for example a ship engine. The features of the claimed computer program product and the claimed computer-implemented method correspondingly apply to the claimed machine installation. Particularly, the claimed machine installation provides an improved monitoring of its emission, for example the composition of its exhaust. Thus, the claimed machine installation may be operated with enhanced cost-efficiency and reduced ecological footprint.

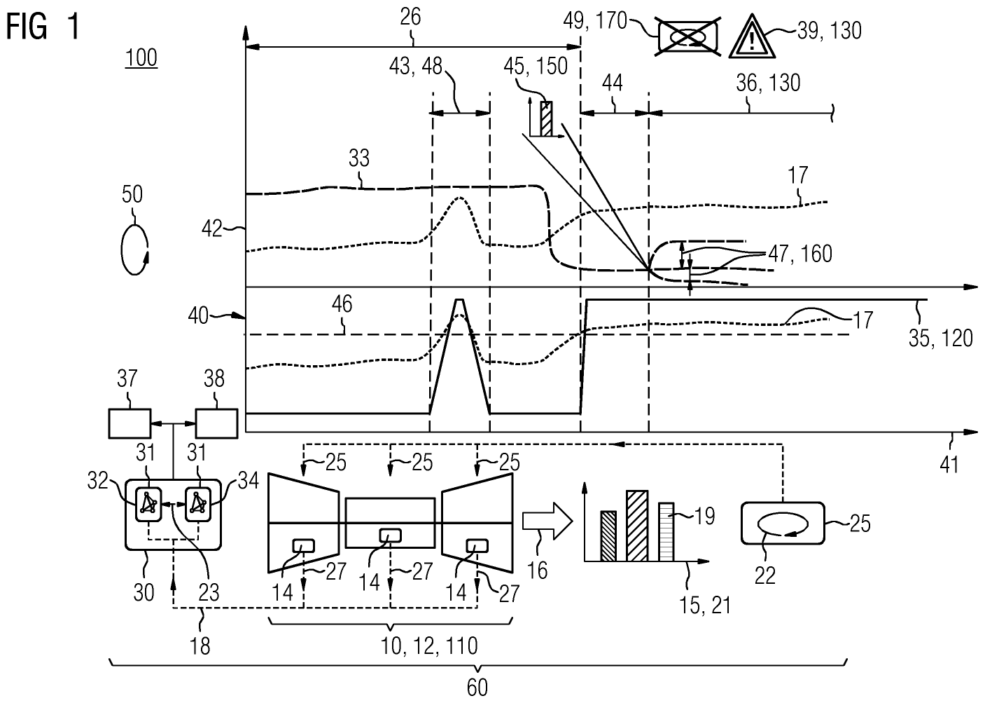

With reference to the figures, FIG. 1 shows a schematic depiction of a first embodiment of the claimed computer-implemented method 100, which is used to monitor a prediction system 32 that is utilized for an operation of a machine 10. The machine 10 is part of a machine installation 60 which also encompasses a control unit 25 that is configured to run a control routine 22 and to send control signals 25 to influence the operation of the machine 10. The machine 10 is a turbo machine 12 that is equipped with multiple sensors 14, each of them being configured to measure a physical quantity that is associated with the operation of the machine 10. The sensors 14 are each configured to output a measurement signal 27 to an evaluation unit 30 through a data link 18. The evaluation unit 30 is configured to convert the measurement signals 27 into measured values 17. The evaluation unit 30 comprises at least one of a transitory or non-transitory memory and a processor which are configured to run a computer program product 50, which is used to perform the computer-implemented method 100. The prediction system 32 is a function that is performed on the evaluation unit 30. In addition to that, the evaluation unit 30 is also equipped with a prediction system 32 that is utilized to predict a process variable 21 of the machine 10. In the embodiment according to FIG. 1, the process variable 21 is a concentration of a component 19 of the exhaust 16 from the machine 10. The composition 15 of the exhaust 16 is schematically shown in FIG. 1, the concentration of the component 19 partly reflecting the composition 15 of the exhaust 15. Both the prediction system 32 and the anomaly detection algorithm 34 are embodied as neural networks 31 which have been trained with the substantially same set of training data. In the course of the computer-implemented method 100, the prediction system 32 and the anomaly detection algorithm 34 are in communication 23 with each other. Furthermore, the evaluation unit 30 is connected to both a display unit 37 that is at least configured to output a warning 39 to a user. Still further, the evaluation unit 30 is connected to a data interface 38 which is configured to transmit at least that warning 39 to the control unit 25 of the machine 10.

The computer-implemented method 100 comprises a first step 110 in which the machine 10 is running and the sensors 14 are sending measurement signals 27 to the evaluation unit 30. The measurement signals 27 are being converted into measured values 17 which directly or indirectly pertain to the process variable 21. Thus, the evaluation unit 30 derives the measured values 17 from the measurement signals 27 and feeds them substantially simultaneously into the prediction system 32 and into the anomaly detection algorithm 34. The measured values 17 are being evaluated at substantially the same time, as shown in a diagram 40 in FIG. 1. The diagram 40 comprises two horizontal time axes 41 and a common vertical value axis 42. For the sake of better overview, the diagram 40 is split into a top portion showing the activity of the prediction system 32 and a bottom portion showing the activity of the anomaly detection algorithm 32. During the first step 110, the measured values 17 are substantially simultaneously fed into the prediction system 32 and into the anomaly prediction algorithm 34. In a second step 120 of the computer-implemented method 100, an anomaly parameter 35 is obtained through the anomaly detection algorithm 34 for each measured value 17.

A third step 130 follows after the second step 120. As shown in a left-hand portion of the diagram 40, the measured value 17 remains substantially constant. At the same time, the prediction system 32 calculates a prediction value 33 for the process variable 21, which is the concentration of the component 19 of the exhaust 16. With the measured value 17 remaining substantially constant, the prediction value 33 remains substantially, too. Furthermore, the measured value 17 temporarily increases and correspondingly, the prediction value 33 decreases. The measured value 17 is checked by an outlier detection algorithm 48 and is identified as an outlier. The temporary increase of the measured value 17 being identified as an outlier, the corresponding portion of the graph of the measured value 17 is suppressed. That constitutes a suppressed portion 43 of the measured value 17 and in turn a suppressed portion 43 of the prediction value 33. For the suppressed portion 43, the prediction value 33 is substituted with an extrapolation of what it has been before the temporary increase of the measured value 17. In other words, the prediction value 33 is handled as if the temporary increase had not occurred. Correspondingly, during the temporary increase of the measured value 17, the anomaly detection algorithm 34 identifies an apparent anomaly since the anomaly parameter 35 exceeds a threshold 46. The corresponding portion of the graph of the anomaly parameter 35 is suppressed or disregarded, too. Consequently, the prediction system 34 is determined to be in a reliable state 26 as long as the anomaly parameter 35 remains below the threshold 46 or outliers which exceed the threshold 46 are being identified as such.

In the course of the third step 130, the measured value 17 shows a remanent increase which exceeds the threshold 46. At substantially the same time, the anomaly detection algorithm 34 determines the anomaly parameter 35, which substantially remains above the threshold. When the anomaly parameter 35 remains above the threshold 36 for at least a predefined time interval 44, the computer-implemented method 100 detects that the prediction system 32 is in an unreliable state 36. In such an unreliable state 36, the prediction values 33 from the prediction system 32 can differ significantly from the real outcome and are not to be used for planning the upcoming operation of the machine 10.

The computer-implemented method 100 also comprises a fourth step 140, in which a warning 39 is output. The warning 39 is output to both a user through the display unit 37 and to the control unit 25 through the data interface 38. In addition to that, the computer-implemented method 100 also comprises a fifth step 150, which is performed substantially when the third step 130 is concluded. In the fifth step 150, the margin of error parameter 45 is determined based on the anomaly parameter 35. Particularly, the margin of error parameter 35 is determined on the amount by which the anomaly parameter 35 exceeds the threshold 46. The more the threshold 46 is exceeded, the higher the margin of error parameter 45 will be. Following that, a sixth step 160 is performed. In the sixth step 160, the margin of error parameter 45 is applied to the prediction value 33. When the margin of error parameter 45 is applied, margins of error 47 are determined for the prediction value 33. The prediction value 33 is displayed in combination with its margins of error 47 through the display unit 37 and transmitted with them through the data interface 38. Based on that, either the user or the control unit 25 is able to decide how to continue with the operation of the machine 10. In the embodiment according to FIG. 1, the computer-implemented method 100 comprises a seventh step 170, in which a control routine 22 on the control unit 25 is disengaged. The disengaged control routine 22 may be substituted by a different control routine, which is not shown in FIG. 1. The disengaged control routine 22 based on prediction values 33 which have been obtained when the prediction system 32 has still been in a reliable state 36. Thus, the disengagement 49 of the control routine 22 prevents the machine 10 from a detrimental mode of operation which has been planned based on assumptions, i.e. predictions, which are not deemed reliable anymore after the third step 130. Therefore, the claimed computer-implemented method 100 allows for a more cost-efficient and environmentally friendly operation.

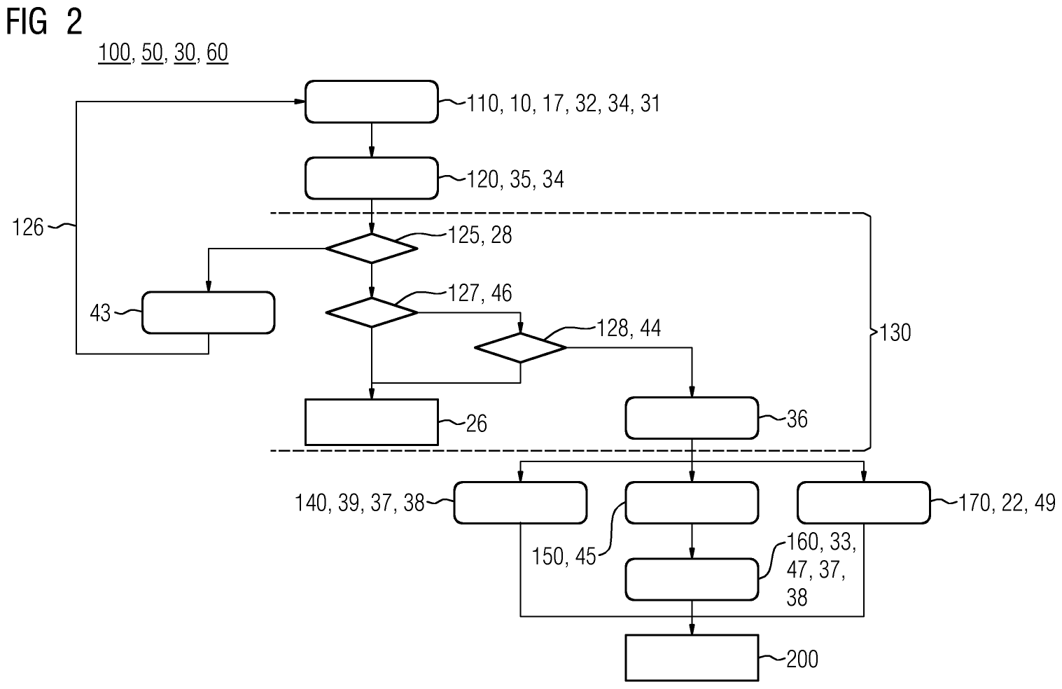

A second embodiment of the claimed computer-implemented method 100 is shown in FIG. 2. Particularly, FIG. 2 shows a flow diagram of such an embodiment of the computer-implemented method 100, which is performed by virtue of a computer program 50 that is being run on an evaluation unit 30 that is connected to a machine 10 and is part of a machine installation 60 which encompasses the machine 10.

In a first step 110, the machine 10 is provided in a running operational state in which several physical quantities are being measured. They are captured and processed as measured value 17 which are being received by the evaluation unit 30. The measured values 17 may each form a time series and are being substantially simultaneously fed into a prediction system 32 and an anomaly detection algorithm 34. Both the prediction system 32 and the anomaly detection algorithm 34 are functionalities provided by the computer program product 50 run on the evaluation unit 30. Both the prediction system 32 and the anomaly prediction algorithm 34 are neural networks 31 which are trained based on substantially the same set of training data.

A second step 120 follows after the first step in which an anomaly parameter 35 is determined through the anomaly detection algorithm 34 based on received measured values 17, each representing a different quantity, the measured values 17 being measured at substantially the same time. The anomaly parameter 35 is obtained and utilized further in the computer-implemented method 100. After the second step 120, there is a first bifurcation 125 of the computer-implemented method 100 which is part of a third step 130. At the first bifurcation 125, an outlier detection algorithm 28 is used to check the received measured values 17. When the outlier detection algorithm 28 determines that one of the measured values 17 is an outlier, the corresponding set of measured values 17 is suppressed. In case of such a suppression 43, the computer-implemented method 100 returns to the first step 110 and substantially restarts. In FIG. 2, this is symbolized by a returning loop 126. When the outlier detection algorithm 28 determines that the received measured values 17 do not comprise an outlier, the third step 130 continues at the second bifurcation 127. At the second bifurcation 127, it is determined if the anomaly parameter 35 exceeds a threshold 46. When the anomaly parameter 35 remains below the threshold 46, a reliable state 26 of the prediction system 32 is detected. In that case, the computer-implemented method 100 terminates.

If the anomaly parameter 35 exceeds the threshold 46, a third bifurcation 127 of the third step 130 occurs. At the third bifurcation 127, it is determined if the anomaly parameter 35 has already exceeded the threshold 46 for at least a predefined time interval 44. If that is not the case, the computer-implemented method 100 determines that the prediction system 32 is still in a reliable state 26 and terminates. If the anomaly parameter 35 has exceeded the threshold 46 for at least the predefined time interval 44, an unreliable state 36 of the prediction system 32 is determined. Either when the computer-implemented method 100 terminates or an unreliable state 36 of the prediction system 32 is determined, the third step 130 is concluded. Subsequent to the third step 130, several steps 140, 150, 160, 170 occur which may be performed at least partly simultaneously.

In a fourth step 140, a warning 39 is output to at least one of a display unit 37 and a data interface 38. The data interface 38 is configured to transmit the warning 39 to a control unit 25 that controls the machine 10, which is not shown in detail in FIG. 2. Furthermore, a fifth step 150 is performed in which a margin of error parameter 45 is determined. The margin of error parameter 45 is determined based on the amount by which the anomaly parameter 35 exceeds the threshold 46 during the third step 1130. In a subsequent sixth step 160, a prediction value 33 is obtained from the prediction system 32. The margin of error parameter 45 is applied to the prediction value 33 to determine its margin of error 47. The amount by which the anomaly parameter 35 exceeds the threshold 46 quantifies to which extend the prediction value 33 is to be expected to be off from reality. Thus, it quantifies with how much of a margin of error 47 the present prediction value 33 comes. During the sixth step 160, the prediction value 33 is output to at least one of the display unit 37, i.e. to a user, and to the data interface 38. Still further, a seventh step 170 is performed in which a control routine 22 of the machine 10 is disengaged. To that end, the computer-implemented method 100 accesses the data interface 38 to transmit a corresponding control signal to the control unit 25 of the machine 10. When that disengagement 49 of the control routine 22 is concluded, the user or a different control routine may be engaged, which is not shown in FIG. 2 in more detail. Once the fourth, fifth, sixth and seventh step 140, 150, 160, 170 are concluded, the computer-implemented method 100 reaches a final state 200 and terminates. The computer-implemented method 100 as shown in FIG. 2 is performed based on the computer program product 50 that is being run on the evaluation unit 30.

1. Computer-implemented method for monitoring a prediction system, the prediction system being configured to predict at least one process variable of a machine based on at least one measured value, the method comprising:
Running the machine, receiving the at least one measured value and substantially simultaneously feeding the received at least one measured value into the prediction system and into an anomaly detection algorithm;
Obtaining an anomaly parameter from the anomaly detection algorithm;
Detecting an unreliable state of the prediction system when the anomaly parameter exceeds a threshold;
Outputting a warning.

2. Computer-implemented method according to claim 1, wherein the prediction system comprises a prediction algorithm that is trained based on substantially the same training data as the anomaly detection algorithm.

3. Computer-implemented method according to claim 1, wherein the unreliable state of the prediction system is detected when the anomaly parameter exceeds the threshold at least for a predefined time interval.

4. Computer-implemented method according to claim 1, wherein the anomaly prediction algorithm is also used to detect anomalies of the machine during its operation.

5. Computer-implemented method according to claim 1, wherein the prediction system comprises a machine-learning algorithm.

6. Computer-implemented method according to claim 5, wherein the machine-learning algorithm is at least one of a gradient boosting machine, a support vector machine, a k-nearest neighbors algorithm, a recurrent neural network, a long short-term memory neural network and a combination thereof.

7. Computer-implemented method according to claim 1, wherein the prediction system comprises a machine-learning algorithm, the machine-learning algorithm.

8. Computer-implemented method according to claim 1, further comprising:
Setting a margin of error parameter based on the anomaly parameter and obtaining a prediction value from the prediction system;
Applying the margin of error parameter to the prediction value and outputting the prediction value with an indication of its margin of error.

9. Computer-implemented method according to claim 1, further comprising:
Disengaging a control routine of the machine that is configured to receive the prediction value from the prediction system as an input when an unreliable state of the prediction system is detected.

10. Computer-implemented method according to claim 1, wherein the machine is at least one of a turbo machine and a reciprocating engine and the prediction system is configured to predict the emissions of the machine.

11. Computer-implemented method according to claim 1, wherein a multitude of anomaly parameters are obtained based on multiple measured values, and wherein the anomaly parameters and/or the measured values are fed into an outlier detection algorithm, wherein a measured value or an anomaly parameter is identified as an outlier.

12. Computer program product comprising a computer-readable program code embodied on a non-transitory storage medium, which when loaded into a memory of an evaluation unit, which is configured to receive and process measured values measured at a running machine, causes the evaluation unit to monitor a prediction system of the machine by
Receiving at least one measured value at the running machine and substantially simultaneously feeding the received value into the prediction system and into an anomaly detection algorithm;
Obtaining an anomaly parameter from the anomaly detection algorithm:
Detecting an unreliable state of the prediction system when the anomaly parameter exceeds a threshold;
Outputting a warning.

13. Evaluation unit for monitoring a prediction system of a machine, comprising a non-transitory memory and a processor for running a computer program product, the evaluation unit being configured to perform:
Receiving at least one measured value measured at the running machine and substantially simultaneously feeding the received value into the prediction system and into an anomaly detection algorithm;
Obtaining an anomaly parameter from the anomaly detection algorithm:
Detecting an unreliable state of the prediction system when the anomaly parameter exceeds a threshold;
Outputting a warning.

14. A machine installation, comprising a machine that is equipped with sensors for measuring multiple measured values relating to an operation of the machine, and an evaluation unit that is connected to the sensors and configured to process measured values from the sensors, the evaluation unit being equipped with a computer program product according to claim 12.
